(19) United States
(12) Patent Application Publication
(10) Pub. No.: US 2014/0327873 A1
(43) Pub. Date: Nov. 6, 2014

(54) TEMPLE AND MOLDING UNIT FOR MAKING THE TEMPLE

(71) Applicant: PROHERO GROUP CO., LTD., Tainan City (TW)

(72) Inventor: PEN-WEI CHEN, TAINAN CITY (TW)

(73) Assignee: PROHERO GROUP CO., LTD., Tainan City (TW)

(21) Appl. No.: 13/886,502

(22) Filed: May 3, 2013

(51) Int. Cl. G02C 5/14; B29C 45/14

(52) U.S. Cl. CPC G02C 5/14; B29C 45/14426
USPC 351/121; 425/500

(57) ABSTRACT

A temple includes a groove defined in at least one side of a metal rod of the temple. The melted material flows from the first and fourth recesses of the first and second molds to the third and sixth recesses of the first and second molds via the groove. The molding unit needs only one pouring entrance to form the front member and the end member connected to the front and rear end of the metal rod. The molding unit saves material and the surplus material is only formed at the pouring entrance. The manufacturing cost is reduced.

### BACKGROUND OF THE INVENTION

1. Fields of the Invention

The present invention relates to a temple of eyeglasses and the molding unit for making the temple, and more particularly, to a temple with front member and end member, and the temple, the front member and the end member are molded integrally.

2. Descriptions of Related Art

The conventional metal temple with a front member and an end member on two ends thereof is disclosed in Taiwan Publish No. M446342. The molding unit for the temple includes two pouring entrances respectively located in the two sides of the molding unit so as to form the front member and the end member. A metal rod is located in the molding unit and the plastic injection machine injects material in the two pouring entrances to form the front member and the end member to the two ends of the temple. There are surplus material formed on the front member and the end member, and the surplus material has to be removed manually. The manual way to remove the surplus material increase the time required and the manufacturing cost. There will be significant material waste generated during the manufacturing processes.

The present invention intends to provide a temple of eyeglasses and the molding unit for making the temple with the front member and the end member, wherein the molding unit improves the shortcomings mentioned above.

### SUMMARY OF THE INVENTION

The primary object of the present invention is to provide a temple with front member and end member connected to two ends thereof. The molding unit integrally manufactures the temple, the front member and the end member.

The present invention relates to a temple for eyeglasses and comprises a metal rod with a front member connected to the front end thereof and an end member connected to the rear end thereof A groove is defined in at least one side of the metal rod and extends from the front end toward the rear end.

Preferably, a connection section is located in the groove and connected between the front member and the end member.

Alternatively, the present invention provides a molding unit for manufacturing a temple, and comprises a first mold having a first cavity and a second mold having a second cavity, wherein the second cavity is located corresponding to the first cavity. The first cavity has a first recess, a second recess and a third recess. The first, second and third recesses are located in sequence and along the axial direction of the first cavity. The second cavity has a fourth recess, a fifth recess and a sixth recess. The fourth, fifth and sixth recesses are located in sequence and along the axial direction of the second cavity. The first, second and third recesses are located corresponding to the fourth, fifth and sixth recesses. The front end of a metal rod is located in the first and fourth recesses. The mediate section of the metal rod is located in the second and fifth recesses. The rear end of the metal rod is located in the third and sixth recesses. A groove is defined in at least one side of the metal rod and extends from the front end toward the rear end. A pouring entrance is defined in the first mold and communicates with either the first recess or the third recess.

The melted material flows from the first and fourth recesses of the first and second molds to the third and sixth recesses of the first and second molds via the groove to form the front member and the end member. The molding unit needs only one pouring entrance to form the front member and the end member connected to the front and rear end of the metal rod. The molding unit saves material and the only surplus material is formed at the pouring entrance.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the temple of the present invention;

FIG. 2 is a cross sectional view showing the molding unit of the present invention and the temple in the molding unit, and

FIG. 3 is an end cross sectional view of the disclosure in FIG. 2.

### DETAILED DESCRIPTION OF THE PREFERRED EMBODIMENT

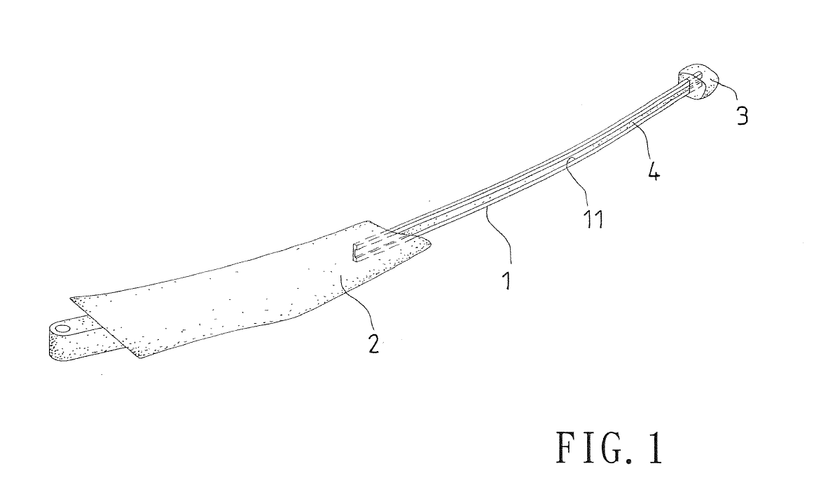

Referring to FIG. 1, the temple of the present invention comprises a metal rod 1, a front member 2 is connected to the front end of the metal rod 1 and an end member 3 is connected to the rear end of the metal rod 1. A groove 11 is defined in at least one side of the metal rod 1 and extends from the front end toward the rear end. A connection section 4 is located in the groove 11 and connected between the front member 2 and the end member 3.

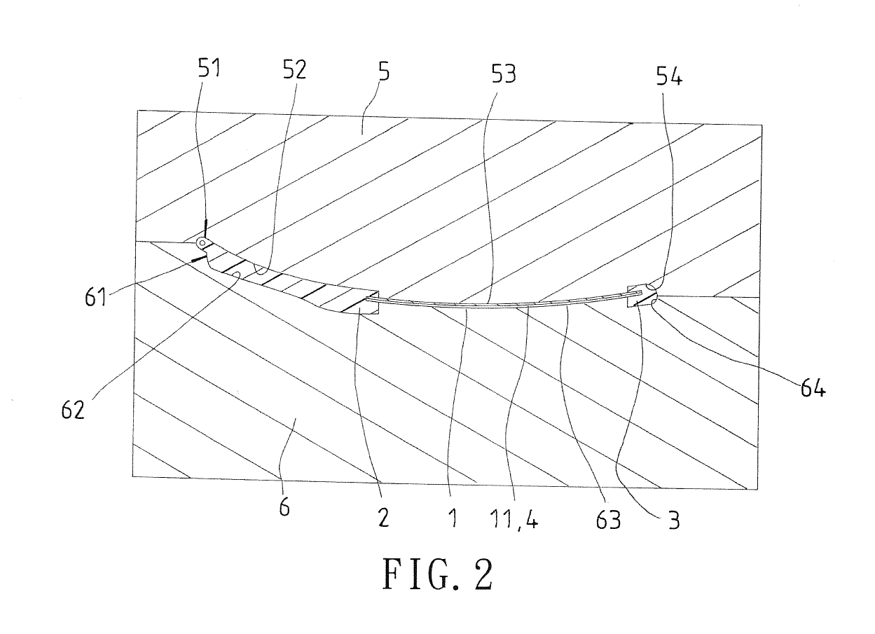

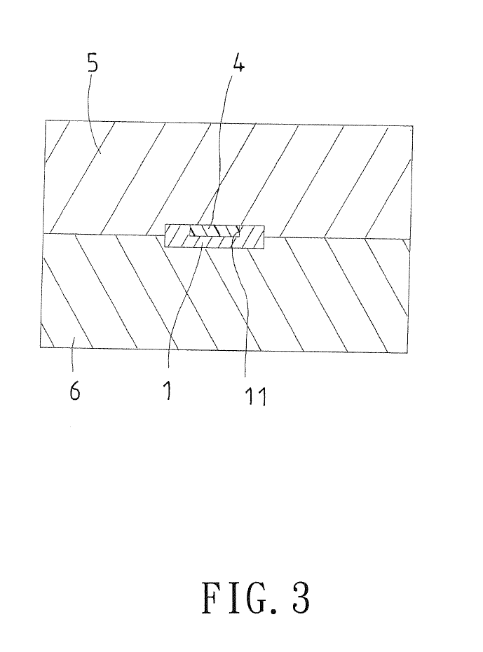

As shown in FIGS. 2 and 3, the molding unit for manufacturing the temple comprises a first mold 5 and a second mold 6, wherein the first mold 5 has a first cavity 51 and the second mold 6 has a second cavity 61 which is located corresponding to the first cavity 51 so as to form a space for manufacturing the temple. The first cavity 51 comprises a first recess 52, a second recess 53 and a third recess 54, wherein the first, second and third recesses 52, 53, 54 are located in sequence and along the axial direction of the first cavity 51. The second cavity 61 comprises a fourth recess 62, a fifth recess 63 and a sixth recess 64, wherein the fourth, fifth and sixth recesses 62, 63, 64 are located in sequence and along the axial direction of the second cavity 61. The first, second and third recesses 52, 53, 54 are located corresponding to the fourth, fifth and sixth recesses 62, 63, 64. A pouring entrance is defined in the first mold 5 and communicates with either the first recess 52 or the third recess 54. In this embodiment, the pouring entrance is located to communicate with the first recess 52 of the first mold 5.

When manufacturing the temple, the metal rod 1 is put in the space formed by the first and second cavities 51, 61. The front end of the metal rod 1 is located in the first and fourth recesses 52, 62, the mediate section of the metal rod 1 is located in the second and fifth recesses 53, 63, and the rear end of the metal rod 1 is located in the third and sixth recesses 54, 64. The melted material is supplied into the space via the pouring entrance which communicates with the first recess 52. The melted material is filled in the first and fourth recesses 52, 62 to form the front member 2. The melted material flows to the third and sixth recesses 54, 64 via the groove 11 defined in at least one side of the metal rod 1. The melted material is filled with the third and sixth recesses 54, 64 to form the end member 3. Eventually, the melted material is filled in the space between the first and second molds 5, 6 via the single pouring entrance so as to form the front member 2 and the end member 3 to the metal rod 1. After the temple is removed from the first and second molds 5, 6, the manufacturers only need to remove the surplus material at the pouring entrance and grind the area at the pouring entrance. This specific arrangement saves material and reduces cost for the post machining.

The pouring entrance can also be defined in the second mold 6 and communicates with the fourth recess 62 or the sixth recess 64 of the second mold 6.

While we have shown and described the embodiment in accordance with the present invention, it should be clear to those skilled in the art that further embodiments may be made without departing from the scope of the present invention.

What is claimed is:

1. A temple for eyeglasses, comprising:
a metal rod, a front member connected to a front end of the metal rod and an end member connected to a rear end of the metal rod, a groove defined in at least one side of the metal rod and extending from the front end toward the rear end.

2. The temple as claimed in claim 1, wherein a connection section is located in the groove and connected between the front member and the end member.

3. A molding unit for manufacturing a temple, comprising:
a first mold having a first cavity and a second mold having a second cavity which is located corresponding to the first cavity, the first cavity having a first recess, a second recess and a third recess, the first, second and third recesses located in sequence and along an axial direction of the first cavity, the second cavity having a fourth recess, a fifth recess and a sixth recess, the fourth, fifth and sixth recesses located in sequence and along an axial direction of the second cavity, the first, second and third recesses located corresponding to the fourth, fifth and sixth recesses, a front end of a metal rod located in the first and fourth recesses, a mediate section of the metal rod located in the second and fifth recesses, a rear end of the metal rod located in the third and sixth recesses, a groove defined in at least one side of the metal rod and extending from the front end toward the rear end, a pouring entrance defined in the first mold and communicating with either the first recess or the third recess.
